(19) United States
(12) Patent Application Publication
(10) Pub. No.: US 2017/0057317 A1
(43) Pub. Date: Mar. 2, 2017

(54) Active Damper System for a Vehicle

(71) Applicant: Bayerische Motoren Werke Aktiengesellschaft, Muenchen (DE)

(72) Inventors: Roland SCHMIDT, Stockdorf (DE); Hubert SCHOLZ, Muenchen (DE)

(21) Appl. No.: 15/343,492

(22) Filed: Nov. 4, 2016

Related U.S. Application Data
(63) Continuation of application No. PCT/EP2015/057685, filed on Apr. 9, 2015.

(30) Foreign Application Priority Data
May 5, 2014 (DE) 10 2014 208 320.6

(51) Int. Cl. B60G 17/08; H02K 7/18; F15B 7/00; B60G 13/14

(52) U.S. Cl. CPC B60G 17/08; B60G 13/14; H02K 7/1823; F15B 7/008; B60G 2202/24; B60G 2202/416; B60G 2202/414; B60G 2300/60; B60G 2500/11

(57) ABSTRACT

An active damper system is provided for a vehicle, in particular a motor vehicle. It includes a damper unit with a cylinder, a piston which is guided in the cylinder, and a piston rod which is connected to the piston. The piston divides the cylinder into a first chamber and a second chamber, and the damper unit is designed to be arranged between a body and a wheel of the vehicle. The damper system also has a pump for changing the pressure in the two chambers and for moving the piston, a first valve, a second valve, which is connected to the first valve in series, a third valve, and a fourth valve, which is connected to the third valve in series. The first and second valve are connected in parallel to the third and fourth valve. A fluid-conductive first line leads to the first chamber between the first valve and the second valve, and a fluid-conductive second line leads to the second chamber between the third valve and the fourth valve. A low-pressure side of the pump is connected between the first valve and the fourth valve, and a pressure side of the pump is connected between the second valve and the third valve. The first valve, the second valve, the third valve, and the fourth valve can be switched in order to selectively block and release the flow of fluid. A control unit is provided for switching the four valves such that the pump rotates in the same direction when compressing and rebounding during an electromotor operation and a generator operation.

### CROSS REFERENCE TO RELATED APPLICATIONS

This application is a continuation of PCT International Application No. PCT/EP2015/057685, filed Apr. 9, 2015, which claims priority under 35 U.S.C. §119 from German Patent Application No. 10 2014 208 320.6, filed May 5, 2014, the entire disclosures of which are herein expressly incorporated by reference.

### BACKGROUND AND SUMMARY OF THE INVENTION

The present invention relates to an active damper system for a vehicle, in particular a motor vehicle.

Damper systems for a vehicle usually include a damper unit having a cylinder and a piston which is guided therein. The cylinder is filled with hydraulic oil. FIG. 6 shows an arrangement according to the prior art for recuperating damper performance. A damper unit 100 is shown, to which four check valves 101 are connected. The check valves 101 are connected to a pump 102. A generator 103 for generating electrical energy is connected to the pump 102. The four check valves 101 achieve a situation where there is only one rotational direction for the pump 102 and therefore for the generator 103 both during compression and during rebound. This has the advantage that the rotating masses of the pump 102 and the generator 103 do not change their rotational direction and therefore substantially do not limit the dynamics of the system. However, this design is not suitable for active actuation of the piston with respect to the cylinder, and therefore for active damping, since the hydraulic liquid always flows back via the corresponding check valves 101 to the pump inlet and no actuating force can be generated in the damper unit 100.

FIG. 7 shows a further arrangement according to the prior art having a damper unit 100, a pump 105 and an electric machine 104. The pump 105 can also be operated as a turbine. Accordingly, the electric machine 104 can be operated both as an electric motor and as a generator. Active actuation of the piston in the cylinder is possible by way of the arrangement according to FIG. 7. However, the rotating masses of the electric machine 104 and the pump 105 change their rotational direction here, as a result of which the dynamics of the system are limited and the result is a low degree of efficiency for the recuperation.

It is an object of the present invention to provide an active damper system for a vehicle, which damper system makes both active actuation of the damper unit and recuperation which is improved in terms of the degree of efficiency possible with inexpensive manufacture and reliable operation. In particular, the active damper system is to make active actuation with the greatest possible recuperation capability possible. The actuating dynamics are to be increased considerably.

These and other objects are achieved for an active damper system for a vehicle, in particular a motor vehicle. The active damper system comprises a damper unit having a cylinder, a piston which is guided in the cylinder, and a piston rod which is connected to the piston. The piston divides the cylinder into a first chamber and into a second chamber. Corresponding damper valves, in particular throttles, are arranged in the piston and/or in the base of the cylinder. By way of movement of the piston in the cylinder, the fluid, in particular hydraulic oil, is moved through the damper valves, as a result of which damping occurs. The damper unit is arranged between a vehicle body and a wheel of the vehicle.

Furthermore, the active damper system comprises a pump, preferably a hydraulic pump, for changing the pressures in the two chambers of the cylinder and, therefore, for moving the piston. The piston can be adjusted with respect to the cylinder by way of the hydraulic pump. This adjustability is possible independently of an excitation by way of the road surface. As a result, this is an active damper system and not an adaptive damper system. Furthermore, the active damper system comprises a first valve and a second valve which is connected in series with the first valve. Furthermore, a third valve and a fourth valve which is connected in series with the third valve are provided. The first and second valves are arranged in parallel with the third and fourth valves. A fluid-conducting first line leads between the first valve and the second valve to the first chamber. A fluid-conducting second line leads between the third valve and the fourth valve to the second chamber. The low pressure side of the pump is connected between the first valve and the fourth valve. The pressure side of the pump is connected between the second valve and the third valve. The first valve, the second valve, the third valve and the fourth valve can be switched for selectively closing and opening the fluid flow. By way of this switchability of the four valves, it is possible that the pump rotates in the same direction in all operating situations. It is therefore possible both to actuate the damper unit and to recuperate energy by way of one rotational direction of the pump.

It is advantageously provided that the first valve, the second valve, the third valve and/or the fourth valve are check valves which can be closed. The check valves always close in the closing direction thereof. For this purpose, a valve body, for example a ball, is usually provided within the check valves, the valve body being pressed in the closing direction against a valve seat by way of the fluid pressure. The check valves can be closed and can therefore be switched, with the result that a fluid flow counter to the closing direction is also blocked in the case of a corresponding switching actuation. There is a very simple design as a result of the configuration of the four valves as check valves, since the valves close in one direction in the non-switched state and also have to be switched in the opposite direction only to block the fluid flow.

The active damper system preferably includes an electric machine which is operatively connected to the pump. The electric machine can be operated as an electric motor in order to drive the pump. Furthermore, the electric machine can be operated as a generator in order to generate electrical energy. Here, the pump acts as a turbine. Both the pump and the electric machine have only one rotational direction in the active damper system according to the invention.

Furthermore, a control unit is preferably provided. The control unit is configured for switching the four valves. The control unit switches the four valves, with the result that the pump and the electric machine always rotate in the same direction both during operation as an electric motor and during operation as a generator.

In each case two of the valves can preferably be actuated in pairs by way of the control unit, with the result that the first valve and the third valve always have the same switching position, and with the result that the second valve and the fourth valve always have the same switching position.

In one preferred embodiment, the control unit for switching the four valves is a hydraulic directional valve. The hydraulic directional valve is connected via control lines to the four valves. The directional valve is connected via a pressure line to the pressure side of the pump. In one preferred embodiment, a 4/3-way valve is used. As an alternative to the use of the directional valve, the four valves can also be actuated via four separate electromagnetic or electromechanical actuators.

The active damper system preferably includes a fluid-conducting direct connection between the pressure side and the low pressure side of the pump. The direct fluid-conducting connection leads directly from the pressure side to the low pressure side of the pump, bypassing the four valves. The direct connection can advantageously be switched by way of the control unit. It is provided here, in particular, that a first additional valve is arranged for the switchability of the direct connection. The first additional valve is advantageously a stop valve which selectively opens or closes the direct connection. As an alternative to the use of the additional valve, the switchability of the direct connection can also be integrated into the above-described directional valve. Here, a 6/3-way valve is advantageously used.

The use of the direct connection between the pressure side and the low pressure side has the advantage that the pump can be kept rotating. Here, the fluid flow can flow back at least partially via the direct connection to the low pressure side. As a result, the fluid pressure can be regulated in a sensitive and highly dynamic manner, since the pump does not have to be accelerated from a standstill. In one particularly preferred embodiment, the first additional valve or its function which is integrated into the directional valve is configured as a proportional valve, with the result that the throughflow quantity can correspondingly be regulated constantly.

As an alternative, the return flow from the pressure side of the pump to the low pressure side of the pump can also take place via the second and first valve or the third and fourth valve. For this function, the above-described 4/3-way valve is configured as a proportional valve. A return flow from the pressure side to the low pressure side is therefore also possible by way of corresponding actuation of the directional valve.

The active damper system advantageously includes a first pressure accumulator which is connected between the first valve and the fourth valve. The first pressure accumulator is therefore connected to the low pressure side of the pump. Furthermore, a second pressure accumulator is advantageously provided which is connected between the second valve and the third valve. The second pressure accumulator is therefore connected to the pressure side of the pump. A second additional valve for controlling the inflow and outflow at the second pressure accumulator is advantageously situated at the inlet of the second pressure accumulator. In particular, the second additional valve has a first switching position, in which merely a fluid flow into the second pressure accumulator is possible, and a second switching position, in which a fluid flow in both directions is possible, advantageously in a throttled manner.

The addition of the first and second pressure accumulator to the active damper system allows pump performance to be buffer-stored in the active mode, that is to say during operation of the electric machine as an electric motor. Load peaks for actuating large damper travels at high damper speeds can therefore be supplied. The first and second pressure accumulator are advantageously of approximately identical size, with the result that the volumes can correspondingly be shifted between the pressure side and the low pressure side.

Moreover, a third additional valve for closing the pressure side of the pump is advantageously provided. The third additional valve is situated, in particular, directly on the pressure side of the pump. The third additional valve allows the pump output to be closed. In special driving situations, in which the damper permanently has to generate a holding force, such as, for example, roll stabilization when driving around a long bend, the electric machine would have to be energized continuously. This leads to overheating of the electric machine and to pronounced loading of the on-board electrical system. The electric machine can be switched off in such situations by way of actuation of the third additional valve and therefore by way of closing of the pressure side of the pump. Here, the second additional valve is advantageously switched, with the result that the second pressure accumulator is attached to the system, in particular via a throttle, and acts as a bearing spring. Here, the advantageous throttle in the second additional valve has a damping action.

The actuation of the directional valve, first additional valve, second additional valve and/or third additional valve advantageously takes place hydraulically, electromagnetically or electromechanically.

Furthermore, a further pressure accumulator is advantageously provided. The further pressure accumulator serves to compensate for the displaced volume during compression of the piston rod. In the case of a twin-tube damper, the further pressure accumulator can be arranged in the double cylinder wall. It is also possible, however, to integrate the function of the further pressure accumulator into the above-mentioned first pressure accumulator.

Furthermore, a pressure relief valve is preferably provided which protects the pump against excessively high pressure shocks.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic circuit diagram of an active damper system according to the invention in accordance with a first exemplary embodiment,

FIG. 2 is a schematic circuit diagram of an active damper system according to the invention in accordance with a second exemplary embodiment,

FIG. 3 is a schematic circuit diagram of an active damper system according to the invention in accordance with a third exemplary embodiment,

FIG. 4 is a schematic circuit diagram of an active damper system according to the invention in accordance with a fourth exemplary embodiment,

FIG. 5 is a schematic circuit diagram of an active damper system according to the invention in accordance with a fifth exemplary embodiment, and

FIGS. 6 and 7 show two arrangements according to the prior art.

### DETAILED DESCRIPTION OF THE DRAWINGS

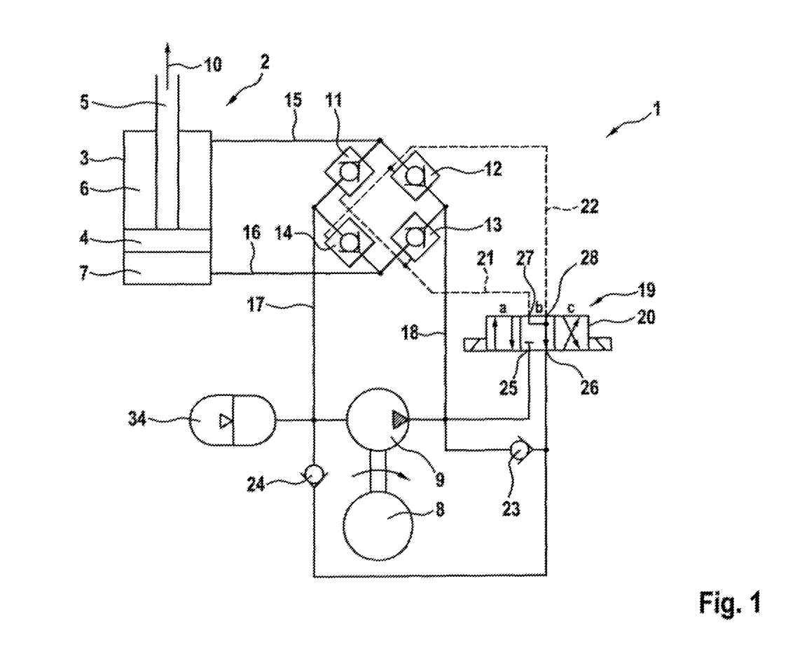

In the following text, five exemplary embodiments of an active damper system 1 for a motor vehicle will be described with respect to FIGS. 1 to 5. Identical or functionally identical components are provided with the same designations in all exemplary embodiments. FIGS. 1 to 5 show the active damper system 1 in a diagrammatically simplified manner.

According to FIG. 1, the active damper system 1 includes a damper unit 2 having a cylinder 3 and a piston 4 which is guided in the cylinder 3. The piston 4 is connected fixedly to a piston rod 5. The piston 4 divides the cylinder 3 into a first chamber 6 and into a second chamber 7. The piston rod 5 extends through the first chamber 6.

The damper unit 2 is arranged in the vehicle between the vehicle body and the wheel. The piston rod 5 is fastened on the vehicle body side. The designation 10 denotes the movement direction of the piston rod 5 during rebound. The damping action is preferably achieved by way of the switching which is shown and the operation of a pump 9 and an electric machine 8 as a generator.

Furthermore, the active damper system 1 includes the pump 9 which can also be operated as a turbine. The pump 9 is operatively connected to the electric machine 8. Both the electric machine 8 and the pump 9 are operated only in one direction. This applies to operation as an electric motor and to operation as a generator during compression and rebound.

Furthermore, the active damper system 1 includes a first valve 11, a second valve 12, a third valve 13 and a fourth valve 14. In the exemplary embodiment which is shown, the four valves 11, 12, 13, 14 are configured as check valves which can be closed. The first valve 11 and the second valve 12 are connected in series. The third valve 13 and the fourth valve 14 are likewise connected in series. The first and second valve 11, 12 are arranged parallel to the third and fourth valve 13, 14. A first line 15 branches off between the first valve 11 and the second valve 12. The first line 15 leads to the first chamber 6. A second line 16 branches off between the third valve 13 and the fourth valve 14. The second line 16 leads to the second chamber 7.

A low pressure line 17 between the first valve 11 and the fourth valve 14 leads to the inlet of the pump 9. A pressure line 18 between the second valve 12 and the third valve 13 leads to the pressure side of the pump 9. Independently of the switching state, the check valves close at least as follows: the first valve 11 closes the fluid flow in the direction of the first chamber 6. The second valve 12 closes the fluid flow in the direction of the pressure side of the pump 9. The third valve 13 closes the fluid flow in the direction of the pressure side of the pump 9. The fourth valve 14 closes the fluid flow in the direction of the second chamber 7.

The valves 11, 12, 13, 14 can be switched by way of a control unit 19, with the result that they also close a fluid flow in the opposite direction.

In the first exemplary embodiment, the control unit 19 comprises a directional valve 20, configured as a 4/3-way valve. From the directional valve 20, a first control line 21 leads to the first valve 11 and to the third valve 13 and a second control line 22 leads to the second valve 12 and to the fourth valve 14. The valves 11, 12, 13, 14 can therefore be switched in pairs via the control lines 21, 22.

The 4/3-way valve 20 has four connectors 25, 26, 27, 28. The first connector 25 and the second connector 26 are connected to the pressure side of the pump 9. By way of the three switching positions a, b, c of the directional valve 20, the first connector 25 and the second connector 26 can be closed in various configurations or can be connected to the third connector 27 and the fourth connector 28. The two control lines 21, 22 are connected to the third connector 27 and to the fourth connector 28.

A first additional check valve 23 is arranged between the second connector 26 and the pressure side of the pump 9. The first additional check valve 23 closes the fluid flow in the direction of the directional valve 20. Furthermore, the second connector 26 is connected via a second additional check valve 24 to the low pressure side of the pump 9. The second additional check valve 24 closes the fluid flow from the low pressure side in the direction of the directional valve 20.

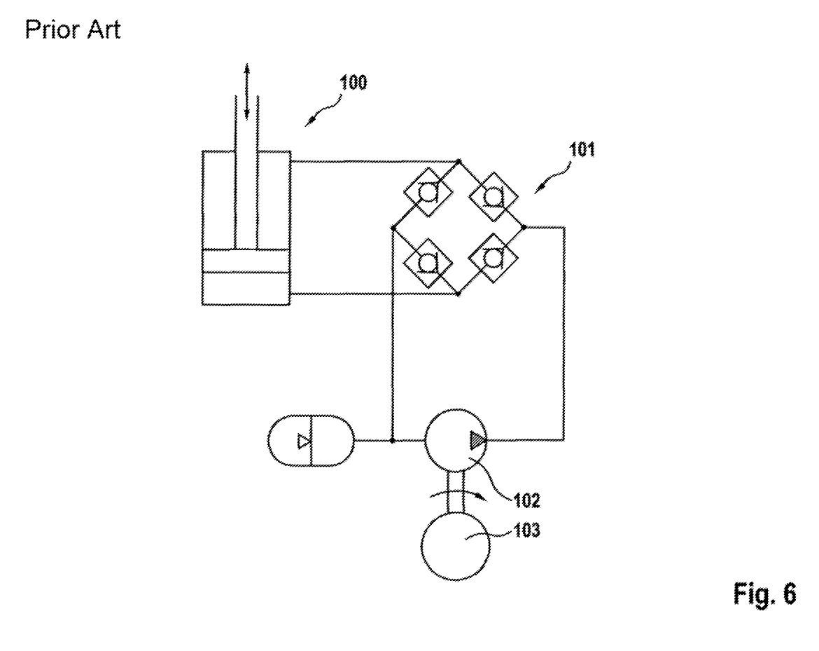

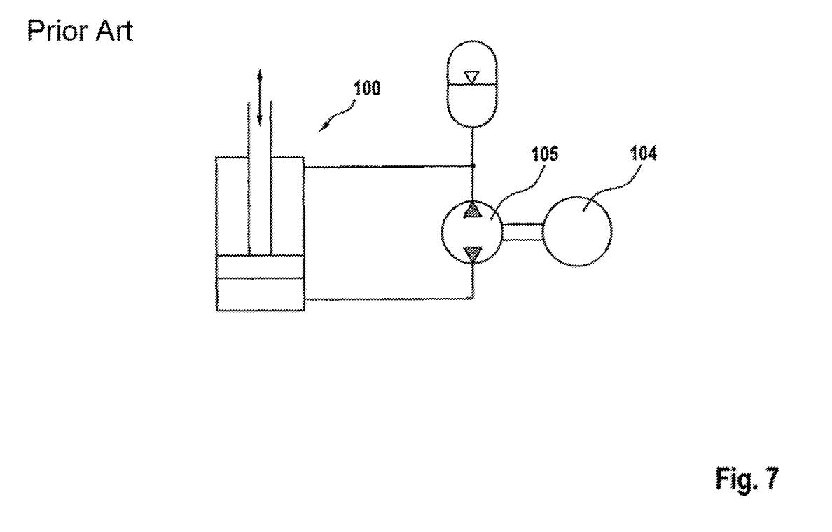

In the switching position b of the directional valve 20, the two control lines 21, 22 are pressureless, with the result that the valves 11, 12, 13, 14 which are configured as check valves close merely in one direction. In the switching position, the function corresponds to the conventional arrangement according to FIG. 6. That is to say, the pump 9 and the electric machine 8 which acts as a generator can be operated in one rotational direction for recuperation.

In the switching position a, the electric machine 8 is operated as an electric motor. Here, the first control line 21 is loaded with pressure, as a result of which the first valve 11 and the third valve 13 close a fluid flow in both directions. Here, the fluid is pumped through the second valve 12 by means of the pump 9. Since the first valve 11 is closed, the fluid cannot flow back to the pump 9 and instead flows into the first chamber 6. The return from the second chamber 7 takes place via the fourth valve 14 to the pump inlet (low pressure side). Here, the damper unit 2 retracts actively.

In the switching position c, the second control line 22 is under pressure. The fluid flows to the cylinder 3 and from the cylinder 3 are reversed with respect to the switching position a, with the result that the damper unit 2 extends actively.

The two additional check valves 23, 24 ensure that the control lines 21, 22 are switched to “pressureless” as required with respect to the low pressure side of the pump 9, in order that the valves 11, 12, 13, 14 are opened.

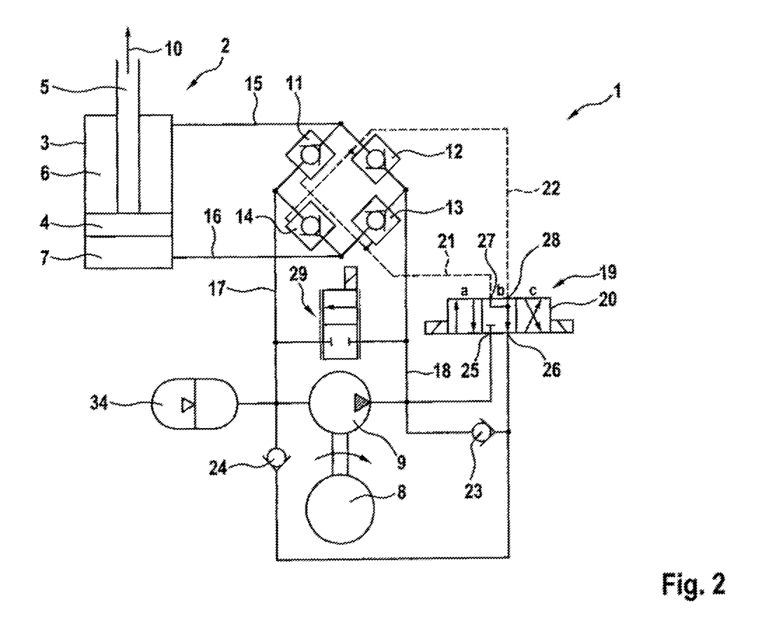

In the second exemplary embodiment according to FIG. 2, a direct fluid-conducting connection is provided between the pressure side of the pump 9 and the low pressure side of the pump 9, that is to say between the pump outlet and the pump inlet. A first additional valve 29 is arranged in the direct connection. The direct connection can selectively be closed or opened by way of the first additional valve 29. If the fluid flow via the direct connection is opened, the pump 9 can be kept rotating. The fluid flow can flow back at least partially via the first additional valve 29 to the pump inlet. As a result, the oil pressure can be regulated in a sensitive and highly dynamic manner, since the pump 9 does not have to be accelerated from a standstill. In an optimum manner, the first additional valve 29 is configured as a proportional valve.

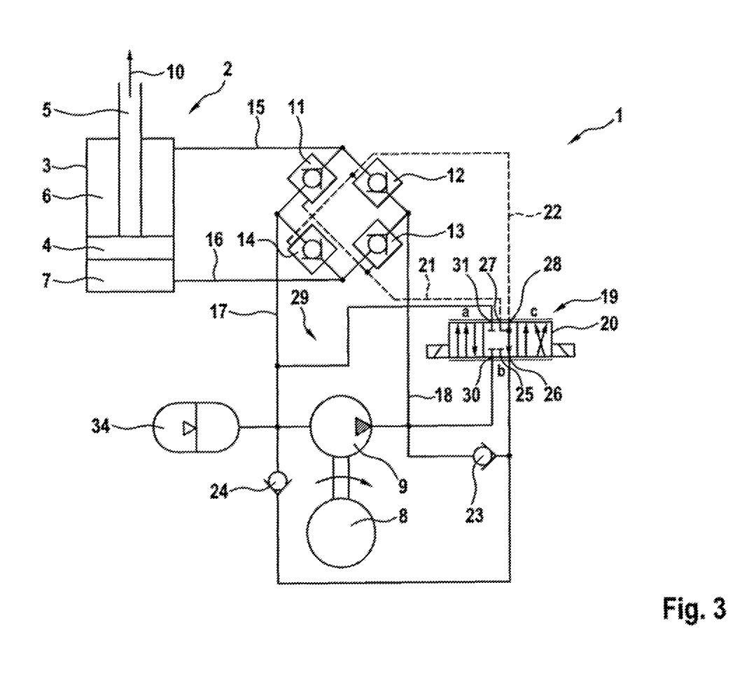

In the third exemplary embodiment according to FIG. 3, there is likewise a direct fluid-conducting connection between the pump outlet and the pump inlet. Here, however, the function of the first additional valve 29 is integrated into the directional valve 20. To this end, the directional valve 20 is configured as a 6/3-way valve. In particular, it is a proportional directional valve. For this embodiment of the directional valve 20, a fifth connector 30 and a sixth connector 31 are additionally provided on the directional valve 20. The fifth connector 30 is connected to the pressure side of the pump 9. The sixth connector 31 leads directly to the low pressure side of the pump 9. In the switching positions a and c, a direct connection takes place between the pressure side and the low pressure side of the pump 9. Here, the direct connection can be regulated proportionally, in particular, with the result that the throughflow quantity can be regulated.

As an alternative to the use of the first additional valve 29 or to the configuration of the directional valve 20 as a 6/3-way valve, it is also possible to configure the 4/3-way valve 20 which is shown in FIG. 1 as a proportional valve. In this configuration as a proportional valve, it is possible to make a direct return flow possible from the pressure side to the low pressure side via the first and second valve 11, 12 or the third and fourth valve 13, 14.

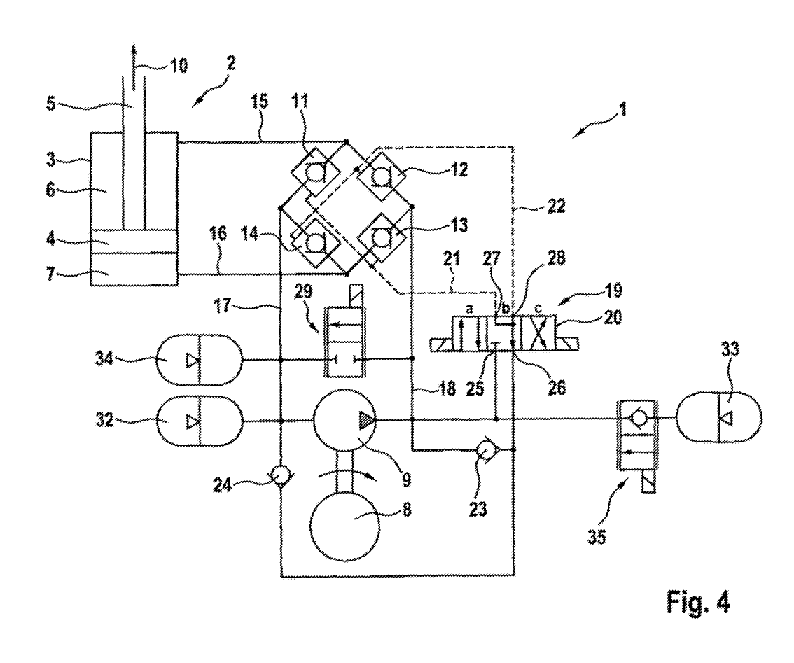

The fourth exemplary embodiment according to FIG. 4 shows a first pressure accumulator 32 which is connected to the low pressure side of the pump 9. A second pressure accumulator 33 is connected to the pressure side of the pump 9. A second additional valve 35 is arranged at the inlet of the second pressure accumulator 33. In a first switching position of the second additional valve 35, a check valve closes the fluid flow from the second pressure accumulator 33 into the pressure line 18. The second switching position of the second additional valve 35 makes a fluid flow possible between the pressure line 18 and the second pressure accumulator 33. Pump performance can be buffer-stored by means of the two pressure accumulators 32, 33. This serves, in particular, for supplying pressure during load peaks.

Furthermore, FIGS. 1 to 5 show a further pressure accumulator 34. The further pressure accumulator 34 is situated on the low pressure side of the pump 9. The further pressure accumulator 34 usually serves to compensate for the displaced volume during compression of the piston rod 5.

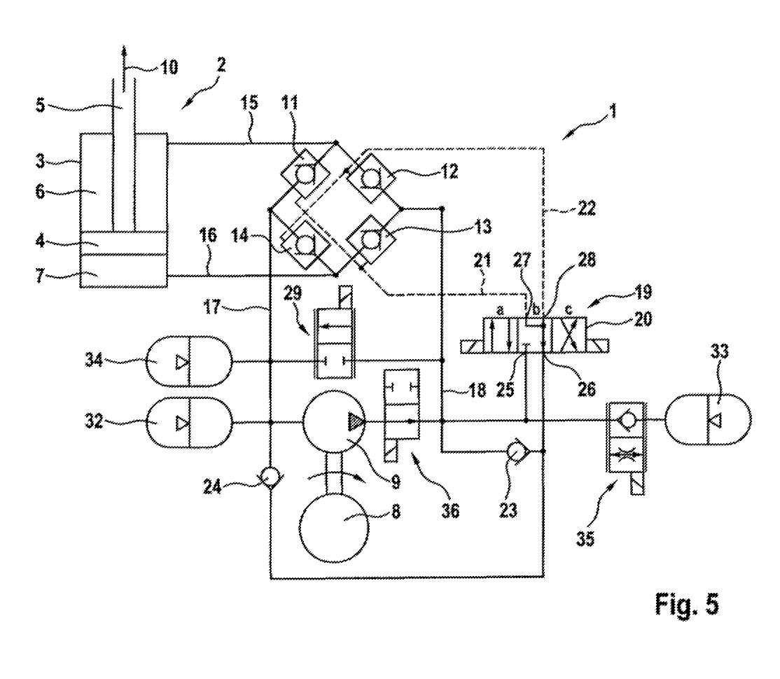

By way of the fifth exemplary embodiment, FIG. 5 shows a third additional valve 36, by way of which the pump inlet can be closed. Furthermore, a throttle is situated here in the second switching position of the second additional valve 35. In certain driving situations, in which the damper unit 2 has to constantly generate a holding force, the electric machine 8 can be switched off. At the same time, the pump inlet is closed via the third additional valve 36. Via the throttle in the second additional valve 35, the second pressure accumulator 33 acts as a bearing spring, the throttle having a damping action. The third additional valve 36 can also be used in the other exemplary embodiments.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

1 Active damper system
2 Damper unit
3 Cylinder
4 Piston
5 Piston rod
6 First chamber
7 Second chamber
8 Electric machine
9 Pump
10 Rebound direction
11, 12, 13, 14 Valves (check valves)
15 First line
16 Second line
17 Low pressure line
18 Pressure line
19 Control unit
20 Directional valve
21 First control line
22 Second control line
23 First additional check valve
24 Second additional check valve
25 First connector
26 Second connector
27 Third connector
28 Fourth connector
29 First additional valve
30 Fifth connector
31 Sixth connector
32 First pressure accumulator
33 Second pressure accumulator
34 Further pressure accumulator
35 Second additional valve
36 Third additional valve
a, b, c Switching positions
100 Damper unit according to the prior art
101 Check valves according to the prior art
102 Pump according to the prior art
103 Generator according to the prior art
104 Electric machine according to the prior art
105 Pump according to the prior art

What is claimed is:

1. An active damper system for a vehicle, comprising:
a damper unit having a cylinder, a piston which is guided in the cylinder, and a piston rod which is connected to the piston, the piston dividing the cylinder into a first chamber and a second chamber, and the damper unit being configured for arranging between a vehicle body and a wheel of the vehicle;
a pump for changing pressures in the first and second chambers and for moving the piston;
a first valve and a second valve which is connected in series with the first valve;
a third valve and a fourth valve which is connected in series with the third valve, wherein the first and second valves are connected in parallel with the third and fourth valves;
a fluid-conducting first line leading between the first valve and the second valve to the first chamber;
a fluid-conducting second line leading between the third valve and the fourth valve to the second chamber, wherein
a low pressure side of the pump is connected between the first valve and the fourth valve,
a pressure side of the pump is connected between the second valve and the third valve,
the first valve, the second valve, the third valve and the fourth valve are switchable for selectively closing and opening the fluid flow; and
a control unit for switching the first, second, third, and fourth valves, with the result that, in electric motor operation and in generator operation, the pump rotates in the same direction, both during compression and during rebound.

2. The active damper system according to claim 1, wherein the first valve, the second valve, the third valve and/or the fourth valve are check valves which can selectively be closed and opened.

3. The active damper system according to claim 1, further comprising:
an electric machine which is operable as an electric motor in order to drive the pump, and which is operable as a generator in order to generate electrical energy by way of the pump.

4. The active damper system according to claim 1, wherein
in each case, two valves are actuatable in pairs by the control unit, with the result that the first valve and the third valve always have the same switching position, and with the result that the second valve and the fourth valve always have the same switching position.

5. The active damper system according to claim 1, wherein the control unit for switching the four valves comprises a directional valve which is connected via control lines to the four valves and is connected via a pressure line to the pressure side of the pump.

6. The active damper system according to claim 5, further comprising:
a fluid-conducting direct connection, which is switchable by the control unit, between the pressure side and the low pressure side of the pump, thus bypassing the four valves.

7. The active damper system according to claim 6, wherein the switchability of the fluid-conducting direct connection is integrated into the directional valve, or wherein a first additional valve is arranged for the switchability of the fluid-conducting direct connection.

8. The active damper system according to claim 1, further comprising:
a first pressure accumulator which is connected between the first valve and the fourth valve; and
a second pressure accumulator which is connected between the second valve and the third valve.

9. The active damper system according to claim 8, further comprising:
a second additional valve for controlling inflow and outflow at the second pressure accumulator; and/or
a third additional valve for closing the pressure side of the pump.

10. The active damper system according to claim 1, wherein the pump is a hydraulic pump.
